(19) United States
(12) Patent Application Publication
(10) Pub. No.: US 2026/0168839 A1
(43) Pub. Date: Jun. 18, 2026

(54) TEST DIPSTICK FOR SEALING AN OIL SUMP DURING AN ENGINE OIL LEAK TEST

(71) Applicant: GM Global Technology Operations LLC, Detroit, MI (US)

(72) Inventors: Jonathan Fernando Hernandez, Leon (MX); Jorge Fernando Rodriguez, Morelia (MX); Octavio Addiel Pichardo, San Luis Potosi (MX); Ricardo Mendez, San Luis Potosi (MX)

(21) Appl. No.: 18/985,770

(22) Filed: Dec. 18, 2024

(51) Int. Cl. G01F 23/04; F16J 15/3284

(52) U.S. Cl. CPC G01F 23/04; F16J 15/3284

(57) ABSTRACT

A test dipstick for sealing an exit port of an engine during an engine oil leak test includes a shaft extending along a central axis and having a first end portion opposite a second end portion. A tip portion is joined to the first end portion, the tip portion having a plurality of sealing features configured to seal to the engine when the dipstick is disposed within the exit port. A handle portion is connected to the second end portion. The handle portion has a base that abuts the engine when the dipstick is disposed within the exit port and has a grip portion extending from the base. The test dipstick comprises a plurality of additive layers, each of the plurality of additive layers parallel to one another, and each of the plurality of additive layers is disposed at an angle relative to the central axis.

The present disclosure relates to a test dipstick, and more particularly, to a test dipstick for sealing an oil sump of an engine during an engine leak test on a production line.

An engine oil leak test is used to determine whether oil seals in an engine are functioning correctly. The oil seals prevent engine oil, which is held in an oil sump and distributed throughout the engine, from leaking out during engine use. The engine leak test confirms the functionality of the oil seals by pressurizing the engine with air and monitoring the pressurized engine for air leaks. Any air leaks are indicative of a potential oil seal failure.

The oil sump includes a passage for providing access to an interior of the engine. To seal the oil sump during the engine leak test, an operator manually seals the passage with a test dipstick. After the engine leak test is complete, the operator removes the test dipstick from the passage. In some cases, the operator manipulation of the test dipstick may cause a portion of the test dipstick to fracture in the passage. The fracturing of the test dipstick may result in pieces of the fractured test dipstick falling into the engine and causing damage.

Thus, while current test dipsticks achieve their intended purpose, there is a need for a new and improved test dipstick for sealing an oil sump during an engine leak test that improves ergonomics and has improved potential part failure.

### SUMMARY

According to several aspects, a test dipstick for sealing an exit port of an engine during an engine oil leak test is provided. The test dipstick includes a shaft extending along a central axis and having a first end portion opposite a second end portion. A tip portion is joined to the first end portion, the tip portion having a plurality of sealing features configured to seal to the engine when the dipstick is disposed within the exit port. A handle portion is joined to the second end portion. The handle portion has a base that abuts the engine when the dipstick is disposed within the exit port and has a grip portion extending from the base. The test dipstick is 3D printed and includes a plurality of additive layers, each of the plurality of additive layers parallel to one another, and each of the plurality of additive layers is disposed at an angle relative to the central axis.

In one aspect, the plurality of sealing features includes a plurality of O-rings disposed along a length of the tip portion.

In another aspect, the plurality of O-rings comprises a first O-ring disposed in a first groove of the tip portion, a second O-ring disposed in a second groove of the tip portion, and a third O-ring disposed in a third groove of the tip portion, and wherein the second O-ring is disposed between the first O-ring and the third O-ring.

In another aspect, the third O-ring has a diameter smaller than a diameter of the second O-ring and a diameter of the third O-ring.

In another aspect, the diameter of the second O-ring is the same as the diameter of the first O-ring.

In another aspect, the angle of the plurality of additive layers relative to the central axis is 50°±5°.

In another aspect, the angle of the plurality of additive layers relative to the central axis is 50°.

In another aspect, the plurality of additive layers is 3D printed, and wherein the 3D print material is Nylon 12.

In another aspect, the handle portion further comprises an end cap disposed on the grip portion opposite the base.

In another aspect, the base and the end cap are defined by a first cross-sectional geometry and the grip portion of the handle is defined by a second cross-sectional geometry different than the first cross-sectional geometry.

In another aspect, the first cross-sectional geometry is defined by a circle with a radius extending perpendicularly from the central axis and the second cross-sectional geometry is defined by a rectangle.

According to several other aspects, a test dipstick for sealing an exit port of an engine during an engine oil leak test is proved. The test dipstick includes a shaft extending along a central axis and having a first end portion opposite a second end portion. A tip portion is joined to the first end portion, the tip portion having a plurality of sealing features configured to seal to the engine when the dipstick is disposed within the exit port. A handle portion is joined to the second end portion. The handle portion has a base that abuts the engine when the dipstick is disposed within the exit port and has a grip portion extending from the base. The test dipstick is 3D printed and comprises a plurality of additive layers, each of the plurality of additive layers parallel to one another, and each of the plurality of additive layers disposed at an angle relative to the central axis, and wherein the angle is 50°±5°.

In one aspect, the plurality of sealing features includes a plurality of O-rings disposed along a length of the tip portion.

In another aspect, the plurality of O-rings comprises a first O-ring disposed in a first groove of the tip portion, a second O-ring disposed in a second groove of the tip portion, and a third O-ring disposed in a third groove of the tip portion, and wherein the second O-ring is disposed between the first O-ring and the third O-ring.

In another aspect, the third O-ring has a diameter smaller than a diameter of the second O-ring and a diameter of the third O-ring.

In another aspect, the diameter of the second O-ring is the same as the diameter of the first O-ring.

In another aspect, the angle of the plurality of additive layers relative to the central axis is 50°.

In another aspect, the plurality of additive layers is 3D printed, and wherein the 3D print material is Nylon 12.

In another aspect, the handle portion further comprises an end cap disposed on the grip portion opposite the base.

According to several other aspects, a test dipstick for sealing an exit port of an engine during an engine oil leak test is provided. The test dipstick includes a shaft extending along a central axis and having a first end portion opposite a second end portion. A tip portion is joined to the first end portion, the tip portion having a plurality of sealing features configured to seal to the engine when the dipstick is disposed within the exit port. The plurality of sealing features includes a plurality of O-rings disposed along a length of the tip portion. The plurality of O-rings includes a first O-ring disposed in a first groove of the tip portion, a second O-ring disposed in a second groove of the tip portion, and a third O-ring disposed in a third groove of the tip portion, and wherein the second O-ring is disposed between the first O-ring and the third O-ring. A handle portion is joined to the second end portion. The handle portion has a base that abuts the engine when the dipstick is disposed within the exit port and has a grip portion extending from the base. An end cap that abuts the grip portion opposite the base. The test dipstick is a 3D printed part comprised of Nylon 12, and the test dipstick comprises a plurality of additive layers, each of the plurality of additive layers parallel to one another, and each of the plurality of additive layers disposed at an angle relative to the central axis, and wherein the angle is 50°±5°.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of an exemplary engine using a test dipstick in accordance with an embodiment of the present disclosure.

FIG. 2 is an isometric view of the test dipstick.

FIG. 3 is a first side view of the test dipstick.

FIG. 4 is a second side view of the test dipstick with O-rings attached.

FIG. 5 is an enlarged, isometric cross-section view of an end of the test dipstick.

### DETAILED DESCRIPTION

The following description is merely exemplary in nature and is not intended to limit the present disclosure, application, or uses.

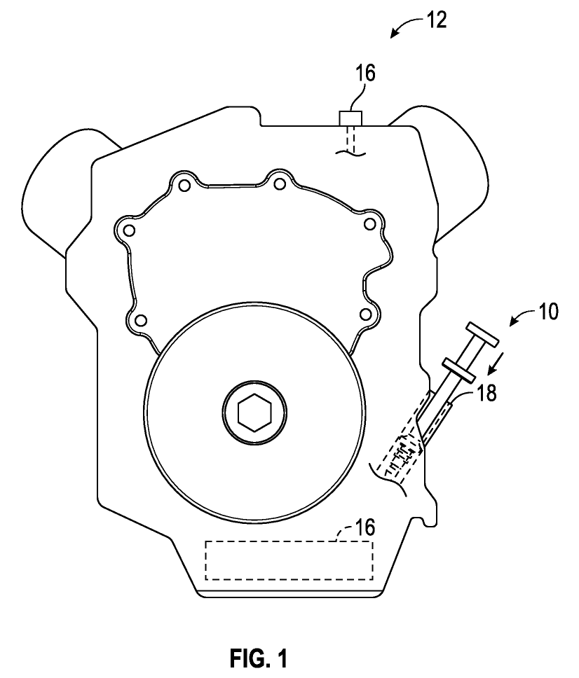

Referring to FIG. 1, a test dipstick according to the principles of the present disclosure is indicated by reference number 10. The test dipstick 10 is shown with an exemplary engine 12. The engine 12 may be any type of internal combustion engine and generally includes an engine block 14 and a sump 16. The sump 16 is used to store engine oil and communicates with a plurality of fluid passages (not shown) within the engine block 14 to distribute oil throughout the engine 12. An oil fill tube 16 and an exit port 18 are disposed in the engine block 14 and each communicate with the sump 16.

During an engine oil leak test performed on the engine 12, pressurized air is introduced into the engine 12 via the oil fill tub 16. The test dipstick 10 is interested by an operator into the exit port 18. The pressure within the engine 12 is then monitored for a period of time to detect any changes in the pressure of the air trapped inside the engine 12. A change in air pressure that exceeds a threshold may indicate a potential engine oil leak.

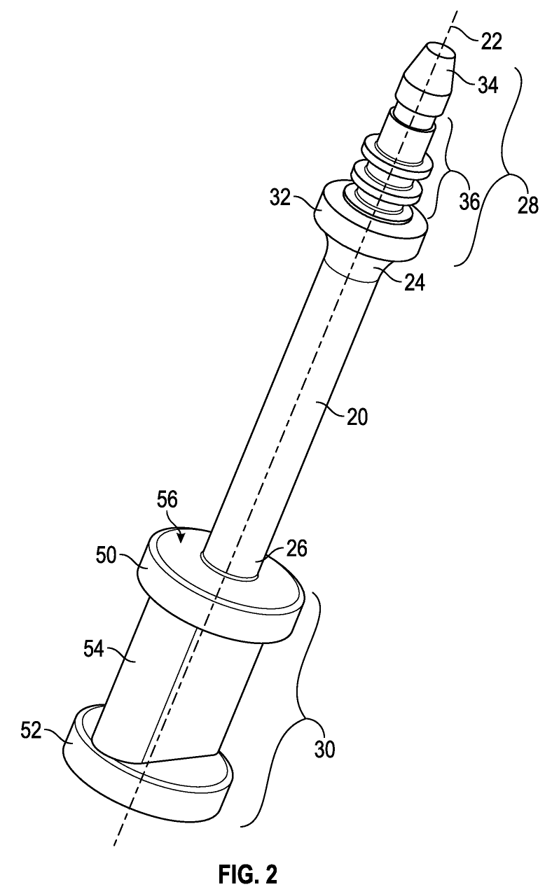

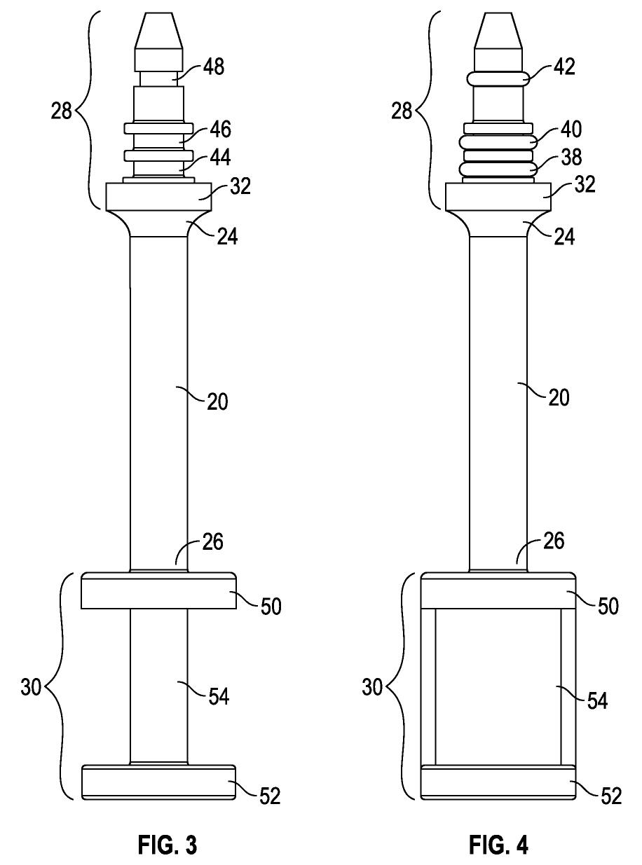

Turning to FIGS. 2-4, the test dipstick 10 will be described in greater detail. The test dipstick 10 includes a shaft 20 that extends along a central axis 22. The shaft 20 includes a first end portion 24 and a second end portion 26 opposite the first end portion 24. A tip portion 28 is joined to the first end portion 24 and a handle portion 30 is joined to the second end portion 26.

The tip portion 28 includes a collar 32 and a distal end 34 opposite the collar 32. The collar 32 is directly joined to the first end portion 24. The distal end 34 is frusto-conical and defines a terminal end of the test dipstick 10. A plurality of sealing features 36 are disposed within the tip portion 28 between the collar 32 and the distal end 34. The plurality of sealing features 36 are configured to seal to the engine block 14 when the test dipstick 10 is inserted into the exit port 18.

The plurality of sealing features 36 extend along a length (.e. along the central axis 22) of the tip portion 28. In the example provided, the plurality of sealing features 36 include a first O-ring 38, a second O-ring 40, and a third O-ring 42, shown attached to the test dipstick 10 in FIG. 4. The first O-ring 38 is disposed in a first groove 44. The second O-ring 40 is disposed in a second groove 46 adjacent the first groove 44. The third O-ring 42 is disposed in a third groove 48 adjacent the second groove 46. In the example provided, the first O-ring 38 and the second O-ring 40 have the same diameter and the third O-ring 42 has a diameter less than that of the first O-ring 38 and the second O-ring 40. Each O-ring 38, 40, and 42 are sized to seal to an inner surface of the exit port 18 in the engine block 14.

The handle portion 30 includes a base 50 and an end cap 52 opposite the base 50. A grip portion 54 extends between the base 50 and the end cap 52. The base 50 is joined to the second end portion 26 of the shaft 20. The base 50 includes a radial surface 56 configured to abut the engine block 14 around the exit port 18 when the test dipstick 10 is inserted into the engine 12. The grip portion 54 is sized to be effectively gripped by a hand of an operator during the engine leak test. Therefore, the base 50 and the end cap 52 are defined by a first cross-sectional geometry and the grip portion 54 is defined by a second cross-sectional geometry different than the first cross-sectional geometry. For example, the first cross-sectional geometry is defined by a circle with a radius extending perpendicularly from the central axis 22. The second cross-sectional geometry is defined by a rectangle. The grip portion 54 is centrally disposed on the base 50 and the end cap 52 is centrally disposed on the grip portion 54 at an end thereof opposite the base 50. This geometry of the handle portion 30 provides an optimized grip for the operator in order to minimize potential part failure.

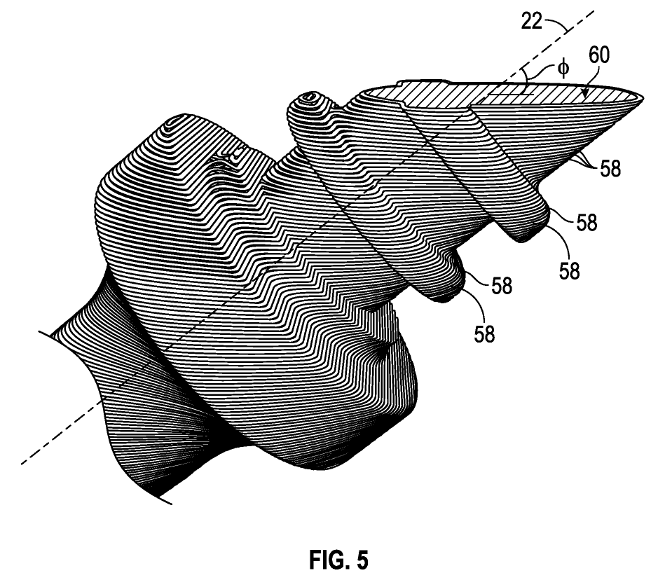

Turning to FIG. 5, the test dipstick 10 is made using additive manufacturing, e.g., 3D printing. In a preferred embodiment, the test dipstick 10 is made from Nylon 12 (Polyamide 12) to provide a smooth texture and to meet durability and flexibility requirements. The entirety of the test dipstick 10, other than the O-rings 38, 40, and 42, is comprised of a plurality of additive layers 58. Each additive layer 58 is parallel to one another. A single additive layer 58 is printed before the next additive layer 58 is started. In addition, a print angle is set to an angle (Φ) relative to the central axis 22. In other words, a planar surface 60 of each additive layer 58 is at the angle (Φ) relative to the central axis 22. In a preferred embodiment, the angle (Φ) is 50 degrees, +- 5 degrees. Therefore, any fracture of the test dipstick 10 will be along one of the plurality of additive layers 58 and along the planar surface 60. This increases a size of the broken part relative to a fractur along an additive layer at print angle of zero degrees (i.e., a planar surface perpendicular to the central axis 22).

The test dipstick 10 of the present disclosure offers several advantages. First, the test dipstick 10 made from additive manufacturing decreases production costs, while improving quality and preventing small pieces from entering the engine during a part failure. In addition, the test dipstick 10 improves operator ergonomics when handling the test dipstick 10.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A test dipstick for sealing an exit port of an engine during an engine oil leak test, the test dipstick comprising:
a shaft extending along a central axis and having a first end portion opposite a second end portion;
a tip portion joined to the first end portion, the tip portion having a plurality of sealing features configured to seal to the engine when the dipstick is disposed within the exit port; and
a handle portion joined to the second end portion, the handle portion having a base that abuts the engine when the dipstick is disposed within the exit port and having a grip portion extending from the base,
wherein the test dipstick comprises a plurality of additive layers, each of the plurality of additive layers parallel to one another, and each of the plurality of additive layers is disposed at an angle relative to the central axis.

2. The test dipstick of claim 1, wherein the plurality of sealing features includes a plurality of O-rings disposed along a length of the tip portion.

3. The test dipstick of claim 2, wherein the plurality of O-rings comprises a first O-ring disposed in a first groove of the tip portion, a second O-ring disposed in a second groove of the tip portion, and a third O-ring disposed in a third groove of the tip portion, and wherein the second O-ring is disposed between the first O-ring and the third O-ring.

4. The test dipstick of claim 3, wherein the third O-ring has a diameter smaller than a diameter of the second O-ring and a diameter of the third O-ring.

5. The test dipstick of claim 4, wherein the diameter of the second O-ring is the same as the diameter of the first O-ring.

6. The test dipstick of claim 1, wherein the angle of the plurality of additive layers relative to the central axis is 50°±5°.

7. The test dipstick of claim 1, wherein the angle of the plurality of additive layers relative to the central axis is 50°.

8. The test dipstick of claim 1, wherein the plurality of additive layers is 3D printed using Nylon 12.

9. The test dipstick of claim 1, wherein the handle portion further comprises an end cap disposed on the grip portion opposite the base.

10. The test dipstick of claim 9, wherein the base and the end cap are defined by a first cross-sectional geometry and the grip portion of the handle is defined by a second cross-sectional geometry different than the first cross-sectional geometry.

11. The test dipstick of claim 10, wherein the first cross-sectional geometry is defined by a circle with a radius extending perpendicularly from the central axis and the second cross-sectional geometry is defined by a rectangle.

12. A test dipstick for sealing an exit port of an engine during an engine oil leak test, the test dipstick comprising:
a shaft extending along a central axis and having a first end portion opposite a second end portion;
a tip portion joined to the first end portion, the tip portion having a plurality of sealing features configured to seal to the engine when the dipstick is disposed within the exit port; and
a handle portion joined to the second end portion, the handle portion having a base that abuts the engine when the dipstick is disposed within the exit port and having a grip portion extending from the base,
wherein the test dipstick is 3D printed and comprises a plurality of additive layers, each of the plurality of additive layers parallel to one another, and each of the plurality of additive layers disposed at an angle relative to the central axis, and wherein the angle is 50° ±5°.

13. The test dipstick of claim 12, wherein the plurality of sealing features includes a plurality of O-rings disposed along a length of the tip portion.

14. The test dipstick of claim 13, wherein the plurality of O-rings comprises a first O-ring disposed in a first groove of the tip portion, a second O-ring disposed in a second groove of the tip portion, and a third O-ring disposed in a third groove of the tip portion, and wherein the second O-ring is disposed between the first O-ring and the third O-ring.

15. The test dipstick of claim 14, wherein the third O-ring has a diameter smaller than a diameter of the second O-ring and a diameter of the third O-ring.

16. The test dipstick of claim 15, wherein the diameter of the second O-ring is the same as the diameter of the first O-ring.

17. The test dipstick of claim 12, wherein the angle of the plurality of additive layers relative to the central axis is 50°.

18. The test dipstick of claim 12, wherein the plurality of additive layers is 3D printed using Nylon 12.

19. The test dipstick of claim 12, wherein the handle portion further comprises an end cap disposed on the grip portion opposite the base.

20. A test dipstick for sealing an exit port of an engine during an engine oil leak test, the test dipstick comprising:
a shaft extending along a central axis and having a first end portion opposite a second end portion;
a tip portion joined to the first end portion, the tip portion having a plurality of sealing features configured to seal to the engine when the dipstick is disposed within the exit port, wherein the plurality of sealing features includes a plurality of O-rings disposed along a length of the tip portion, wherein the plurality of O-rings comprises a first O-ring disposed in a first groove of the tip portion, a second O-ring disposed in a second groove of the tip portion, and a third O-ring disposed in a third groove of the tip portion, and wherein the second O-ring is disposed between the first O-ring and the third O-ring; and
a handle portion joined to the second end portion, the handle portion having a base that abuts the engine when the dipstick is disposed within the exit port and having a grip portion extending from the base, and having an end cap that abuts the grip portion opposite the base,
wherein the test dipstick is a 3D printed part comprised of Nylon 12, and wherein the test dipstick comprises a plurality of additive layers, each of the plurality of additive layers parallel to one another, and each of the plurality of additive layers disposed at an angle relative to the central axis, and wherein the angle is 50°±5°.
